(19) United States
(12) Patent Application Publication
(10) Pub. No.: US 2024/0377550 A1
(43) Pub. Date: Nov. 14, 2024

(54) COMPLETION AND WELL PLACEMENT OPTIMIZATION USING DISTRIBUTED FIBER OPTIC SENSING IN NEXT-GENERATION GEOTHERMAL PROJECTS

(71) Applicant: Fervo Energy Company, Houston, TX (US)

(72) Inventors: Jack Norbeck, Golden, CO (US); Aleksei Titov, Golden, CO (US)

(21) Appl. No.: 18/659,712

(22) Filed: May 9, 2024

Related U.S. Application Data
(60) Provisional application No. 63/465,116, filed on May 9, 2023.

(51) Int. Cl. G01V 1/46; F24T 10/20; G01B 11/16; G01K 11/32; G01V 1/50

(52) U.S. Cl. CPC G01V 1/46; F24T 10/20; G01B 11/16; G01K 11/32; G01V 1/50; F24T 2201/00; G01V 2210/1429

(57) ABSTRACT

Systems and techniques may be used to obtain information corresponding to a well of a reservoir. An example technique may include drilling a first well, inserting a fiber optic cable into the first well, sending a laser pulse down the fiber optic cable, and capturing distributed fiber optic sensing (DFOS) data. The example technique may include determining, based on the DFOS data, well placement parameters for a second well, and outputting the well placement parameters for the second well.

### PRIORITY CLAIM

This application claims the benefit of U.S. Provisional Application No. 63/465,116, filed on May 9, 2023, titled, “COMPLETION AND WELL PLACEMENT OPTIMIZATION USING DISTRIBUTED FIBER OPTIC SENSING IN NEXT-GENERATION GEOTHERMAL PROJECTS,” which is hereby incorporated by reference in its entirety.

### STATEMENT REGARDING FEDERALLY SPONSORED RESEARCH OR DEVELOPMENT

This invention was made with government support under award number DEEE0007080 from the U.S. Department of Energy. The government has certain rights in this invention.

### BACKGROUND

Geothermal energy is essential in a growing demand for the energy transition. Compared with other renewable electricity-generating technologies, geothermal power is constantly available, providing a sustainable baseload for customers. Conventional geothermal (hydrothermal) reservoirs have hot water in place and high permeability within the reservoir. Therefore, the energy can be harvested through the production of geothermal fluid. The produced hot fluid can be converted to steam to rotate a turbine to generate electricity or heat a working fluid with a lower boiling temperature, which evaporates and is used to rotate the turbine. The latter type of geothermal plant is called a closed-loop binary cycle power plant, as geothermal fluid is injected back into the reservoir. However, economically viable hydrothermal reservoirs are limited, and alternative design is required to develop more geothermal resources.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a horizontal geothermal well system, in accordance with some examples.

FIG. 2 illustrates a wells layout for monitoring, injector, and producer including a map and section view, in accordance with some examples.

FIG. 3 illustrates distributed fiber optic sensing (DFOS) monitoring during horizontal geothermal well system development, in accordance with some examples.

FIGS. 4A-4D illustrate examples of distributed temperature sensing (DTS) data, in accordance with some examples.

FIGS. 5A-5D illustrates examples of distributed acoustic sensing (DAS) data, in accordance with some examples.

FIG. 6 illustrates a histogram of slurry per cluster distribution for recorded in-well DAS data, in accordance with some examples.

FIGS. 7A-7B illustrate horizontal and vertical slices through the vertical strain change volume due to hydraulic stimulation of the stage in the middle of a lateral, in accordance with some examples.

FIGS. 8A-8C illustrate examples of low frequency DAS (LFDAS) data, in accordance with some examples.

FIGS. 9A-9B illustrate LFDAS data recorded during 16-stage stimulation of injector well recorded in vertical monitoring well, in accordance with some examples.

FIG. 10 illustrates strain change recorded in producer after the injection test in the injector with seven heel-most stages open to a reservoir, in accordance with some examples.

FIG. 11 illustrates a flowchart showing a technique for obtaining information corresponding to a well of a reservoir, in accordance with some examples.

FIG. 12 illustrates generally an example of a block diagram of a machine upon which any one or more of the techniques discussed herein may perform in accordance with some examples.

### DETAILED DESCRIPTION

A commercial next-generation geothermal project may adopt one or more unconventional technologies, such as horizontal drilling, plug-and-perf stimulation, and reservoir diagnostics with distributed fiber optic sensing (DFOS). In an example, a geothermal project may include installed permanent fiber optic cables cemented behind casing, such as in one or more wells (e.g., two, three, four, five, etc.). Recorded DFOS data may include in-well or cross-well distributed temperature sensing (DTS), distributed acoustic sensing (DAS), or distributed strain sensing (DSS) data. DFOS may be used in geothermal applications for example to optimize multi-stage completions, characterizing a stimulated reservoir volume, or determining well placement in geothermal reservoirs.

A set of wells may include wells in a high-temperature (350° F. to 375° F.), low-permeability geothermal reservoir in a mixed metasedimentary and granitic formation. In-well and cross-well (in vertical well) DFOS data may be acquired during stimulation treatment performed on a first horizontal well, for example. This data may be used for characterizing plug-and-perf completion design, evaluating fracture initiation and flow allocation, or guiding a decision on a second horizontal well placement (e.g., a producer) to establish a flow path between the wells via an induced fracture network.

DTS data from a vertical well may be used to validate a thermal model to place a first horizontal well. During stimulation of the first horizontal well, in-well DAS and DTS data may be used for obtaining information related to fracture initiation, slurry and proppant distributions at the cluster level, or thermal warmback behavior. The information may be used to validate or improve completion design for a following stimulation. Integrated analysis of cross-well strain data recorded in a vertical well and two-well DAS-based microseismic data may be used to constrain stimulated reservoir volume (SRV) height and length. In some examples, a decision on a second horizontal (e.g., producer) well placement may be made based on the DAS-based seismic data. Cross-well DSS data recorded in a producer may be used to determine a flow path between two wells during an injection test of the injector.

An example well may include a 16-stage plug-and-perf stimulation treatment in a high-temperature mixed metasedimentary and granitic formation in a fully horizontal geothermal well. Cross-well strain data during stimulation of a geothermal well may be recorded. DFOS data may be acquired with a plurality (e.g., three) fiber-instrumented wells. In-well DAS data may indicate that all clusters were opened during fracture initiation, and that treatment uniformity was high. Strain change signals from induced fractures may be detected over large distances (e.g., greater than 1500 ft).

Creating an enhanced geothermal systems (EGS) may be a solution to expand geothermal energy production. With the help of EGS, geothermal energy may be harvested from hard, dry, tight rocks (e.g., no water in place with low permeability). Typical EGS systems include a vertical injector-producer pair and are usually completed with hydraulic cold water injection stimulation without proppant. The engineered fracture network connects the wells and creates a heat exchanger for geothermal production.

To further improve the economic output of EGS systems, advanced horizontal geothermal well systems may be created. Such systems directly utilize available unconventional oil and gas technologies. They include horizontal directional drilling, multi-stage hydraulic stimulation with proppant, and limited entry design.

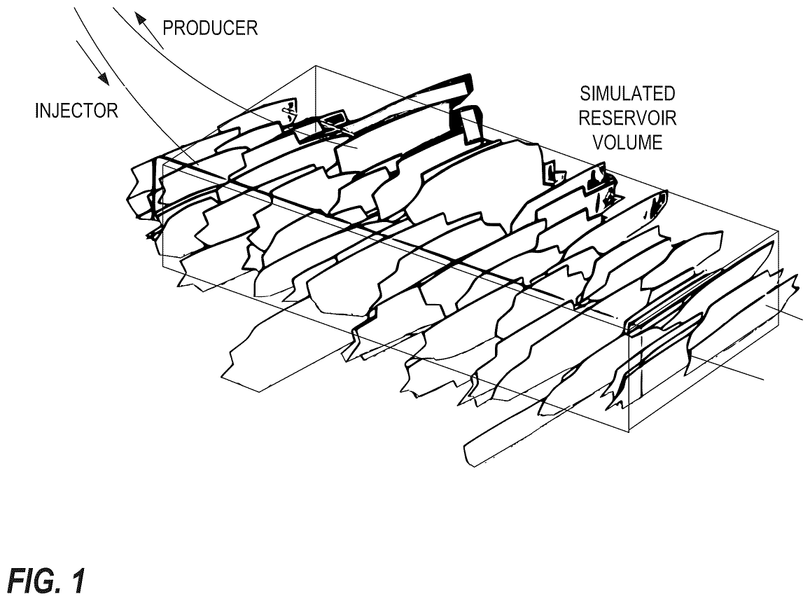

FIG. 1 illustrates a horizontal geothermal well system, in accordance with some examples. Stimulated reservoir volume created through hydraulic stimulation of the wells with proppant acts as a subsurface heat exchanger in low-permeable, hot, dry reservoirs. Cold water is supplied through the injector, and hot fluid is produced via the producer well.

FIG. 1 illustrates the horizontal geothermal well system. It includes a horizontal injector-producer pair (doublet) and propped, hydraulically stimulated reservoir volume around it, which acts as the subsurface heat exchanger, allowing for geothermal energy production.

In some examples, leading-edge diagnostics tools for stimulation and reservoir monitoring may be used to optimize advanced horizontal geothermal well systems. One such technology is distributed fiber optic sensing (DFOS). DFOS turns a fiber optic cable into a dense (˜10 ft spatial spacing) sensor array of temperature, strain, or strain-rate sensors. DFOS may use a fiber optic cable secured in the wellbore and an interrogator unit (IU) located on the surface. IU includes a laser, optoelectronic analyzer, and digital acquisition system (e.g., a photodetector). IU sends a pulse (or series of pulses) down the cable and analyzes a reflected optical signal utilizing Raman, Brillouin, or Rayleigh scatterings (e.g., backscatter) which naturally occur in optical fiber and hold information about temperature and strain fields affecting the fiber cable. The fiber cable may be permanently cemented behind the casing, conveyed with wireline, coiled tubing, or rigid rod. The bare fiber may be utilized as a single-use sensor deployed using a special shuttle. The applications of DFOS for stimulation monitoring include temperature profiling, in-well slurry and proppant allocation, cross-well strain or low-frequency DAS (LF-DAS) monitoring in offset horizontal or vertical wells, microseismic monitoring, vertical seismic profiling, perforation shot analysis, or the like. During production, the DFOS data may be used to generate production profiles.

Special fiber-optic cables may be designed for high temperatures, for example to withstand high heat (e.g., 500 F or more), which makes them a good choice for geothermal reservoir monitoring, as no active equipment with electronics can survive such harsh conditions. DFOS systems may be used to monitor conventional geothermal systems, such as for temperature monitoring or seismic reservoir characterization. DAS may be used for microseismic or induced seismicity monitoring of EGS systems.

In an example, three wells may be drilled, for example in the following order: vertical monitor (73-22), horizontal injector (34A-22), and horizontal producer (34-22). The wells may target Grass Valley formation composed of interlayered phyllite, and quartzite intruded by diorite and granodiorite dike swarms. The expected reservoir temperature varies in the 350 F to 375 F range along the lateral portion of the horizontal wells.

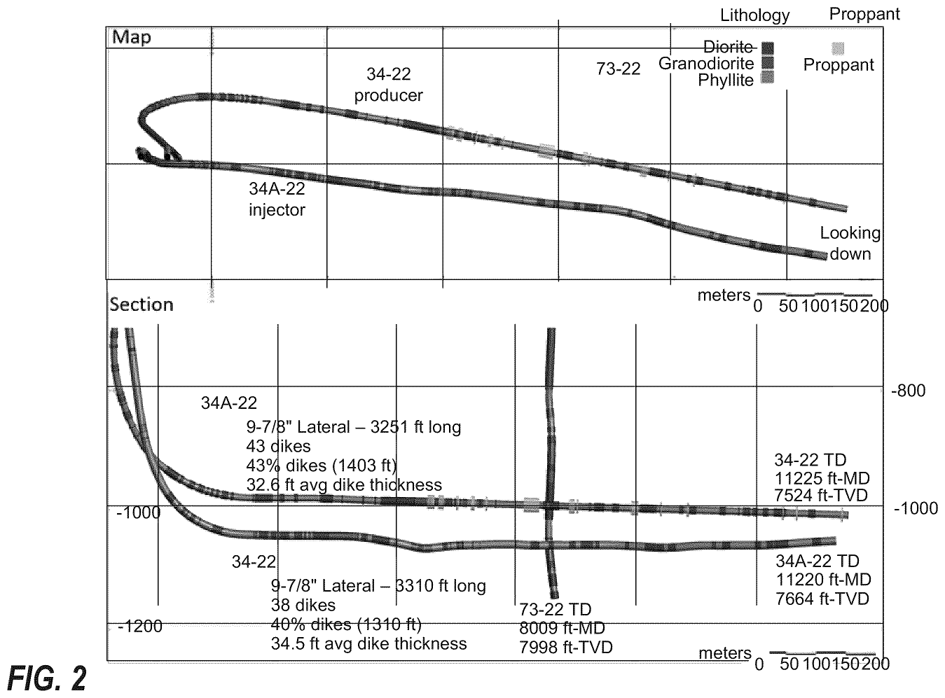

FIG. 2 illustrates a wells layout for monitoring (73-22), injector (34A-22), and producer (34-22): map and section view, in accordance with some examples. The lithologies and proppant distribution are identified. TD in terms of MD and TVD is indicated.

The wells layout shown in FIG. 2 illustrates lithological variations along the well paths and detected proppant in 34-22 producer obtained from mud logs.

A well may include a fiber optic cable cemented behind the casing (e.g., the fiber optic cable may be inserted into the well). Each cable may have two single-mode or two multi-mode fibers embedded into a metal tube filled with (fiber-in-metal tube (FIMT) cable type). This allows for acquiring unique DFOS datasets to optimize well placement and evaluate completion design.

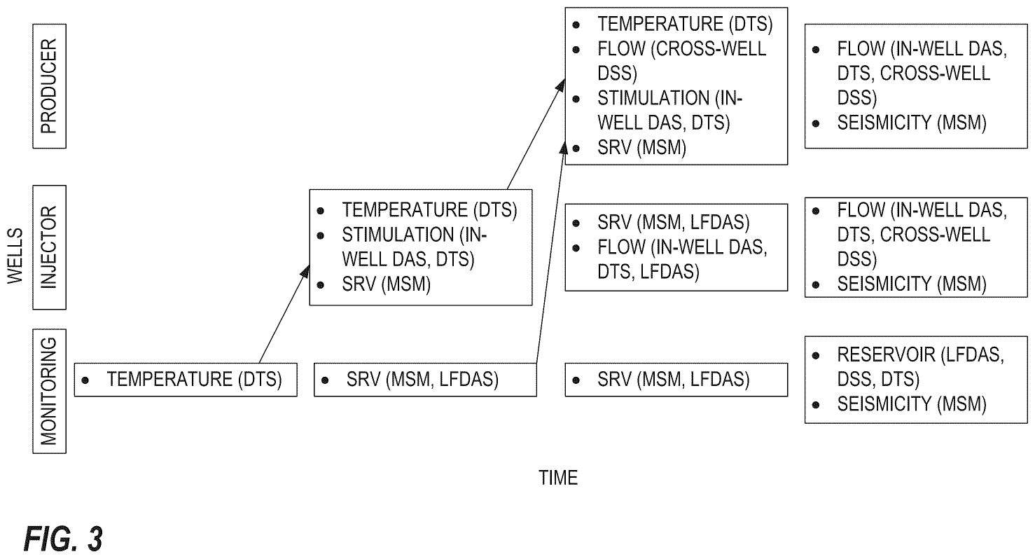

FIG. 3 illustrates distributed fiber optic sensing (DFOS) monitoring during horizontal geothermal well system development, in accordance with some examples. The arrows indicate the datasets used to optimize the placement of the next drilled well.

FIG. 3 illustrates DFOS monitoring utilization over a field development time. The schematic is valid for any horizontal well geothermal system. Various types of monitoring include temperature, stimulation, stimulated reservoir volume (SRV), flow, and seismicity monitoring. The used datasets may include DTS, in-well DAS (including acoustic noise, speed of sound, heat slug, or perforation shot analyses), DAS-based microseismic monitoring (MSM), cross-well low-frequency DAS (LFDAS), DSS data, or the like.

A fiber cable and downhole P/T gauge may be cemented behind a casing. DTS data may be used to calibrate a temperature model, which may be used to optimize the placement of a first horizontal well (injector). The injector may be drilled and instrumented. In-well DAS and DTS data may be used to characterize slurry and proppant distribution on a cluster level during injector stimulation. LFDAS data may be recorded in the monitoring well and microseismic data may be recorded in both monitoring and injector wells to characterize SRV. The recorded LFDAS response may be modeled in ResFrac software, for example using history-matched simulation to understand the topology of the signals and estimate SRV geometric parameters. The estimated SRV properties may be used to place the producer. When the producer is drilled and instrumented but not yet stimulated, an injection test may be run into a partially opened injector (e.g., 7 heel-most stages opened to the reservoir). High-resolution DSS data may be acquired in the producer.

During producer stimulation, cross-well LFDAS may be recorded in the monitoring well, and microseismic data may be captured in wells to characterize SRV volume.

DTS data may be used to generate or confirm a 3D temperature model of the reservoir. After drilling, the wells may be left to equilibrate for several weeks. The stabilized temperatures may be compared with wireline temperature logs. Using the temperature profile from the monitoring well, the injector may be placed at an appropriate distance below the surface, such as with a horizontal offset. The well trajectories may be driven by 3D temperature distribution and local stress state.

An injector may be completed using 16 stage plug-and-perf design. The average stage length may be about 150 ft, with 14 stages having 6 clusters per stage, and 6 perforations per cluster, except stages 14 and 15, with 9 clusters per stage and variable shots per cluster. During stimulation of the injector, in-well DAS and DTS data may be recorded for some or all of the 16 stages.

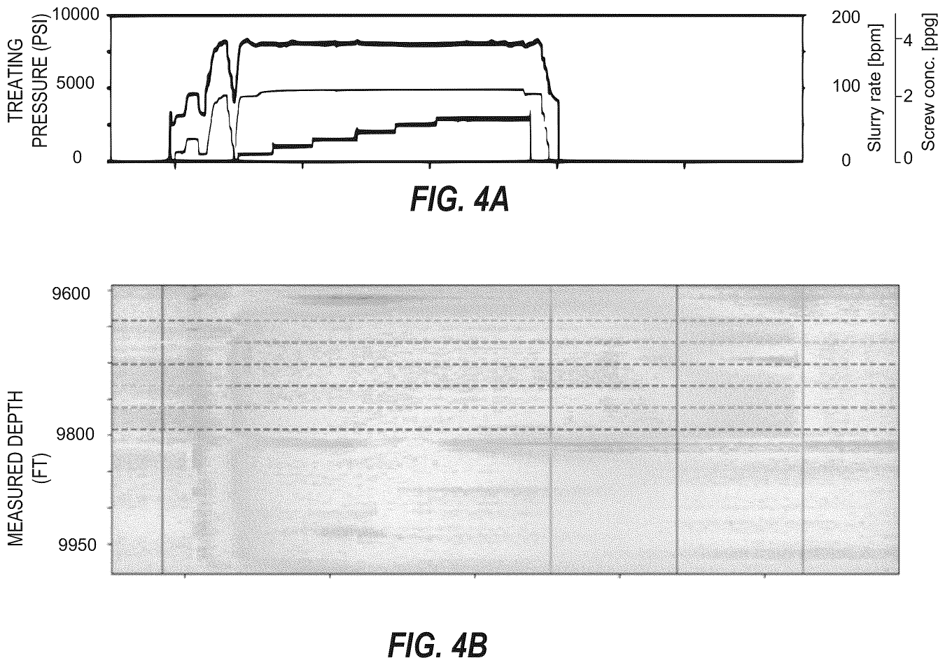

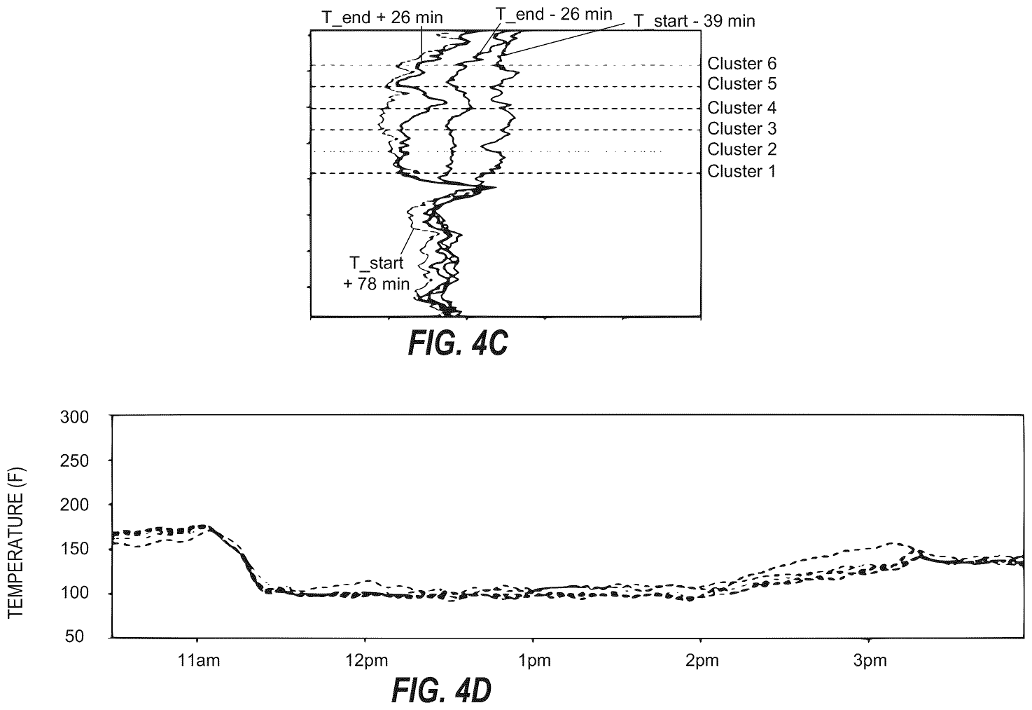

FIGS. 4A-4D illustrate examples of distributed temperature sensing (DTS) data, in accordance with some examples. FIG. 4A is a treatment plot showing surface injection pressure, injection rate, and proppant concentration. FIG. 4B is a DTS waterfall plot, where solid vertical lines correspond to times of selected temperature profiles in FIG. 4C, horizontal dashed lines are related to depths of the clusters within the stage, and corresponding temporal temperature variations at these depths are shown in FIG. 4D.

Examples of the treatment curve and corresponding DTS data for a stage are shown in FIGS. 4A-4D. To evaluate data semi-quantitatively, temperature profiles for different times before, during, and after the stage are shown in FIG. 4C, and temperature variation with time for cluster depths are shown in FIG. 4D. In the provided example, all clusters cool down at the beginning of the stage. Upon the stage end, warm back begins. Minor communication occurs with the previous stage (cooling signal), especially during the first half of the stage. Note that the temperature inside the wellbore is about 100 F during stimulation, despite the initial undisturbed temperature of 360 F. The in-situ temperature measurements confirm previously done modeling.

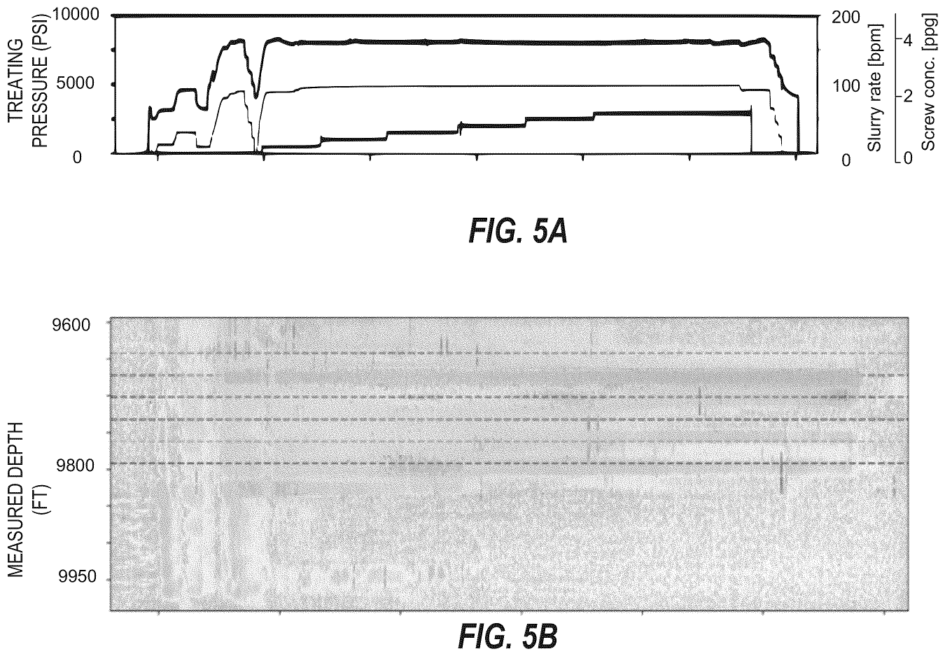

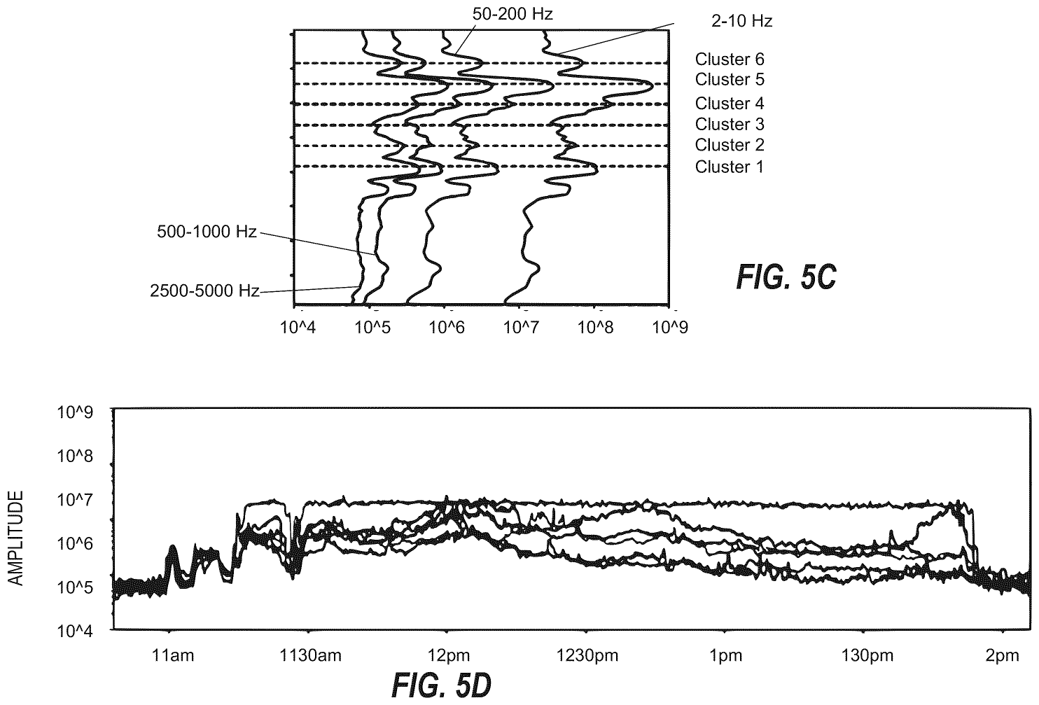

FIGS. 5A-5D illustrates examples of distributed acoustic sensing (DAS) data, in accordance with some examples. FIG. 5A is a treatment plot showing surface injection pressure, injection rate, and proppant concentration. FIG. 5B is a DAS FBE waterfall plot for 500-5000 Hz band, where horizontal dashed lines indicate clusters depth within the stage. FIG. 5C shows average amplitude for different frequency bands. FIG. 5D shows temporal amplitude variations (500-5000 Hz band) at cluster depths.

FIGS. 5A-5D illustrate in-well DAS data for the same stage as FIGS. 4A-4D. When the slurry and proppant flow through perforation, significant broadband acoustic noise is created, proportional to the flow rate. Raw DAS data may be used to plot a waterfall plot for the 500-5000 Hz band (FIG. 5B), average amplitudes in different bands during the treatment (FIG. 5C), and amplitudes at cluster depths for the 500-5000 Hz band (FIG. 5D). All clusters were taking fluid during the treatment. Cluster 5 stayed active during the stage of treatment and was the most active. Clusters 2 and 4 also took significant slurry volume based on recorded acoustic noise intensity. Various cluster activation timing can be related to changes in proppant concentration and limited entry nature. FIG. 5C shows that the frequency bands indicate a similar slurry distribution within the stage. DAS data confirm communication with a previous stage, which stops in the middle of the treatment of the current stage. The character and behavior of the communication indicate the possible near-wellbore communication. DAS-derived slurry volume per cluster values may be used to understand the uniformity of slurry distribution for all measured stages.

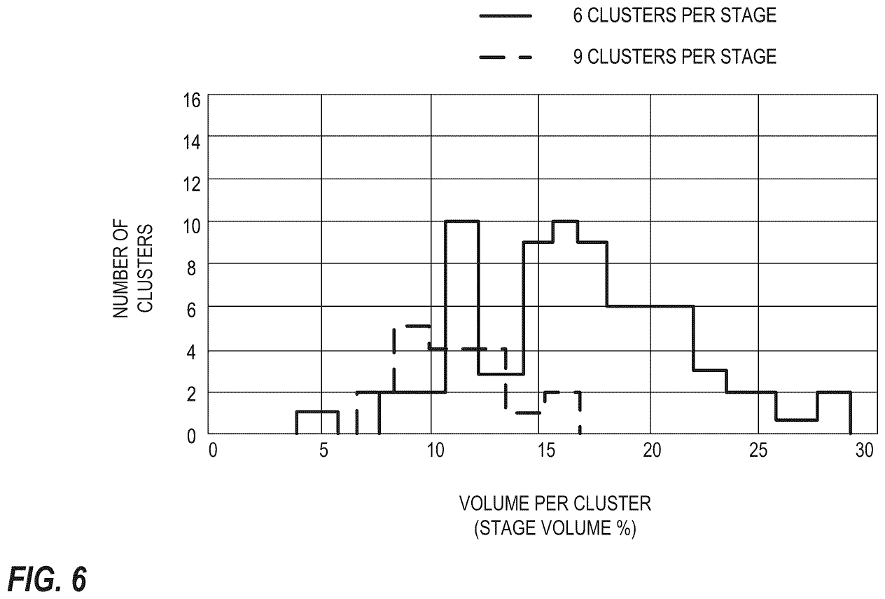

FIG. 6 illustrates a histogram of slurry per cluster distribution for recorded in-well DAS data, in accordance with some examples. In this example, 11 stages with 6 clusters per stage and 2 stages with 9 clusters per stage were analyzed. The ideal uniform distribution is about 16.7% for 6 clusters per stage, and 11.1% for 9 clusters per stage. Both designs demonstrate good flow distribution.

FIG. 6 demonstrates that good uniformity was achieved for stages with 6 and 9 clusters per stage. Note that for the 6 cluster stage, the ideal uniform distribution is related to about 16.7% of stage volume per cluster, and for the 9 cluster stage, to approximately 11.1%. Only 3 clusters took more than 25% of stage volume, and no clusters took less than 5%.

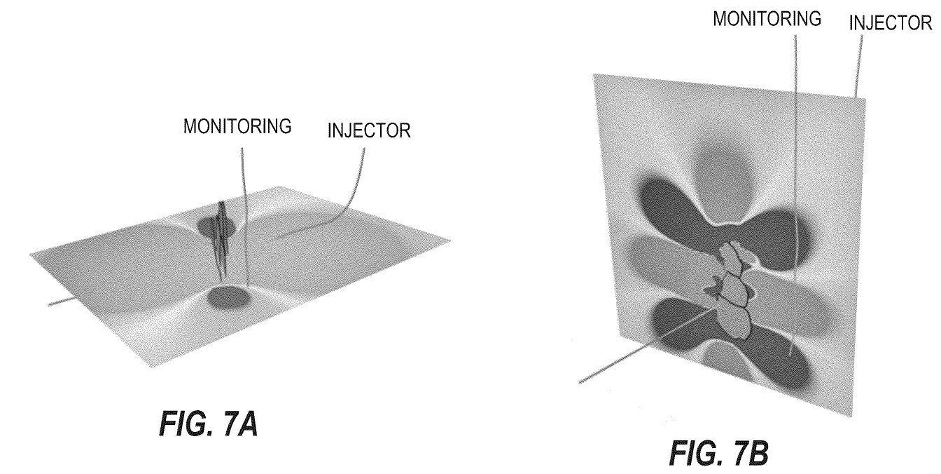

FIGS. 7A-7B illustrate horizontal (FIG. 7A) and vertical (FIG. 7B) slices through the vertical strain change volume due to hydraulic stimulation of the stage in the middle of a lateral, in accordance with some examples. The lighter areas indicate vertical extension, while the darker areas indicate vertical compression. The length of the lateral section is about 3,000 ft.

High-quality cross-well LFDAS data was obtained in an offset vertical well, which provided a reliable estimate of the fracture height during the stimulation proving that cross-well LFDAS may be used to estimate the geometrical properties of SRV. To understand the topology of strain distribution induced during hydraulic stimulation of fractures, vertical strain change may be modeled after 2 hours of stimulation for a stage in the middle of the lateral section. The corresponding distributions of vertical strain in horizontal and vertical planes are shown in FIGS. 7A-7B. FIG. 7A demonstrates that poroelastic deformation caused by hydraulic stimulation in hard rocks causes significant stress shadow in a wide area around the induced fractures (>1,500 ft). The shadow strength depends on the aperture, length, height, and azimuth of induced hydraulic fractures. In the simulated case, a 30-degree SHmax orientation was introduced, and the strain distribution was symmetric relative to this direction. This causes differences in responses for the toe and heel stages, as for the toe stages, the monitoring well is located in a “strong” shadow, while for the heel stage, in a “weak” shadow. FIG. 7B indicates that the polarity shift along the monitoring well depth axis is related to the height of induced shadow, which is related to the height of hydraulic fractures. Hence, this polarity reversal location (transition from extension to compression zone) can be used to estimate the height of induced fractures.

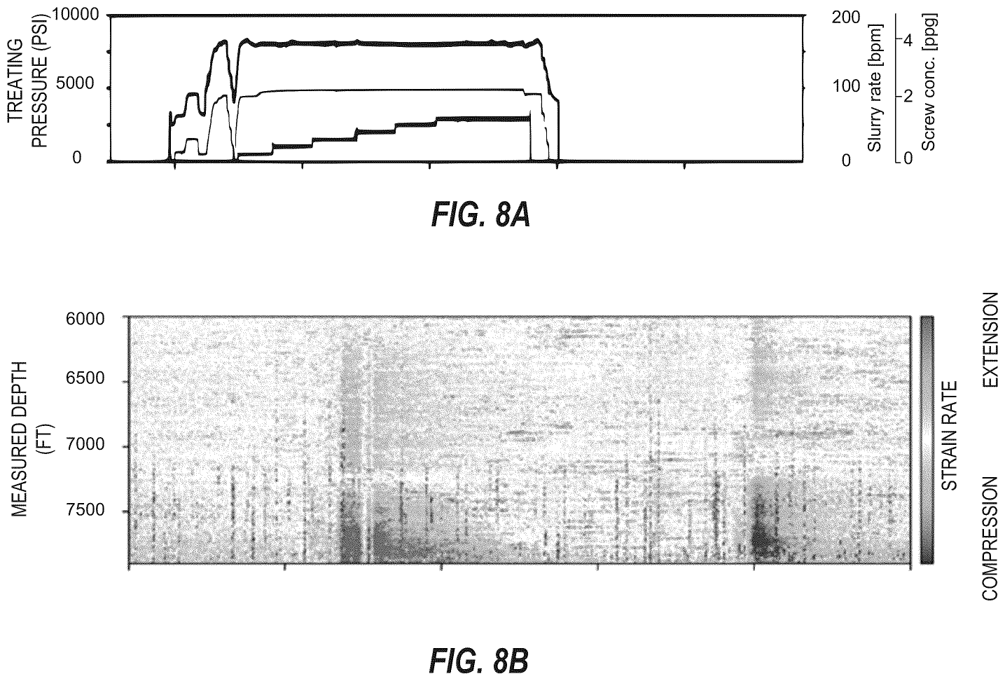

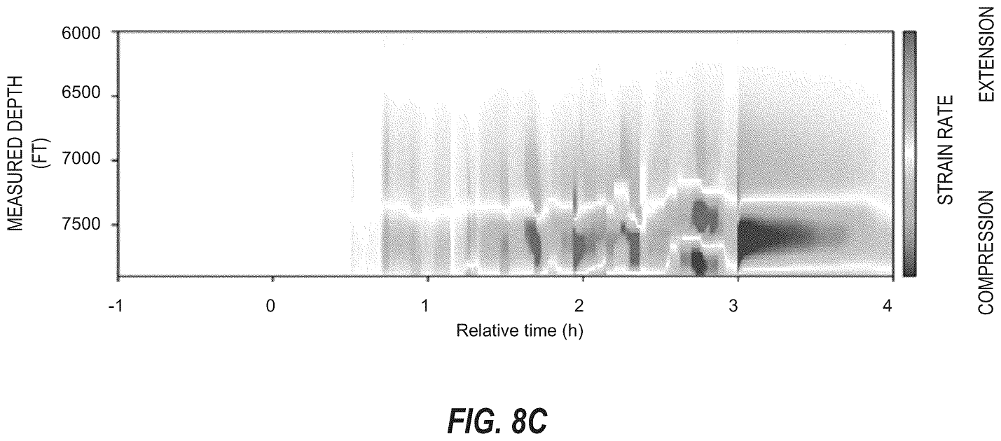

FIGS. 8A-8C illustrate examples of low frequency DAS (LFDAS) data, in accordance with some examples. The LFDAS data may include data captured during the completion of a stage. FIG. 8A is a treatment plot showing surface injection pressure, injection rate, and proppant concentration. FIG. 8B includes recorded LFDAS data. FIG. 8C illustrates modeled LFDAS data.

An example of a recorded and modeled LFDAS signal in terms of strain rate for a stage is shown in FIGS. 8A-8C. As soon as the stage pumping started, the fractures opened almost instantaneously with about 450 ft half-height. The rapid response indicates not only fast growth in height but also fast growth in length to more than the horizontal offset between the injector and monitoring well (800 ft). As the pumping stops, the polarity changes along the time axis related to fracture closure. The modeled response has similar features.

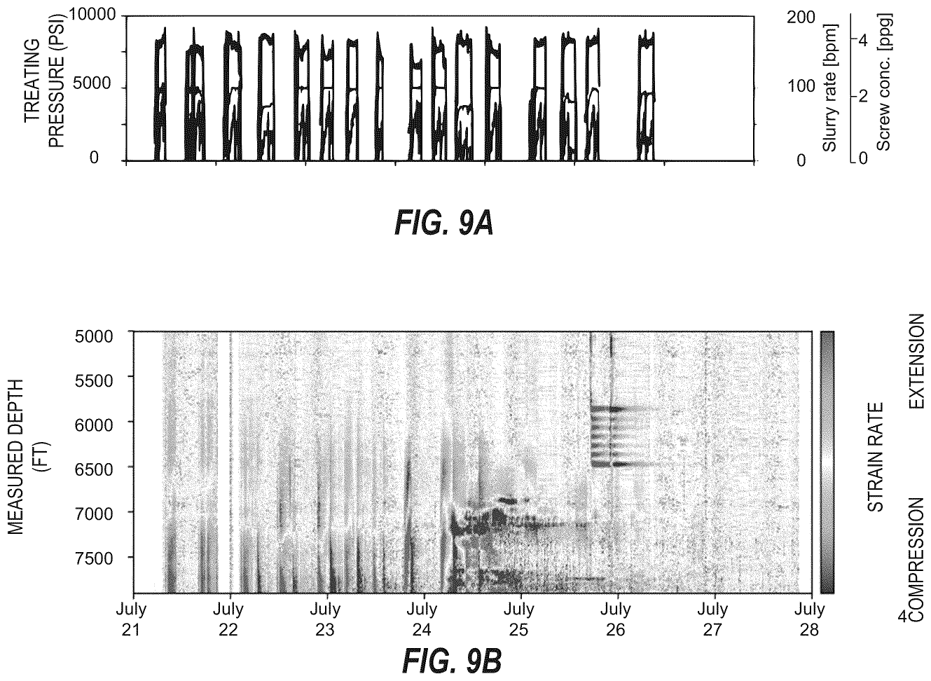

FIGS. 9A-9B illustrate LFDAS data recorded during 16-stage stimulation of injector well recorded in vertical monitoring well, in accordance with some examples. FIG. 9A is a treatment plot showing surface injection pressure, injection rate, and proppant concentration. FIG. 9B illustrates a corresponding LFDAS signal.

FIGS. 9A-9B illustrate the LFDAS response for all 16 stages. The location of polarity change along the depth axis corresponds to the height of the stress shadow induced by hydraulic fractures. Polarity reversal after the end of each stage corresponds to fracture aperture change (it increases during stimulation and decreases right after that). Seven stripes from 5,500 ft to 6,500 ft measured depth around 26 July are due to the heating/cooling of the downhole geophone array installed in the monitoring well. The strain change in the vertical monitoring well started from the first stimulation stage, which was more than 1,500 ft away from the monitoring well. The response was similar to the one discussed above with respect to FIGS. 8A-8C until a later stage. During stimulation of the later stage, the fractures may directly hit the monitoring well, which causes more complex strain rate patterns. The recorded and modeled data were compared. It was found that the further away from the monitoring well the stage is located, the higher the corresponding shadow height. Hence, the fracture and shadow heights are almost equal for the stages near the monitoring well. The height estimation for stages 1-9 is more reliable than for stages 10-16, as the response from the heel-most stages is much weaker, which can be caused by fracture propagation azimuth, as was discussed above with respect to FIGS. 7A-7B. The average fracture half-height was estimated to be about 400 ft, and the half-length of about 800 ft.

Integrating results of LFDAS, microseismic monitoring, the dimensions of SRV volume were estimated to be 1800 ft×3000 ft×750 ft. Considering the SRV characteristics and refined 3D temperature model, the producer was placed 400 ft away from the injector horizontally to the north and 200 ft shallower. This was a conservative choice to guarantee hydraulic communication between the injector and producer wells. During the drilling of the producer, through the previously stimulated reservoir volume, proppant was detected in the mud logs for several depths (see e.g. FIG. 2). After the producer was drilled and instrumented with fiber cable, an injection test was performed in the injector well, with seven heel-most stages open to the reservoir. During this test, high-resolution DSS data were acquired in a closed producer to validate communication between the wells via change of fractures aperture during transient periods of the injection test.

Rayleigh frequency shift (RFS) DSS was to measure relative strain changes through the injection test period. A warming back signal after drilling the well complicated the data, which caused a significant positive strain change signal. The injection test lasted 4 days, with an average flow rate of 4 bpm. Before the end of the injection test, the rate was increased to 10 bpm and held for one hour. The signal of interest in DSS data was detected right after the injector well shut in.

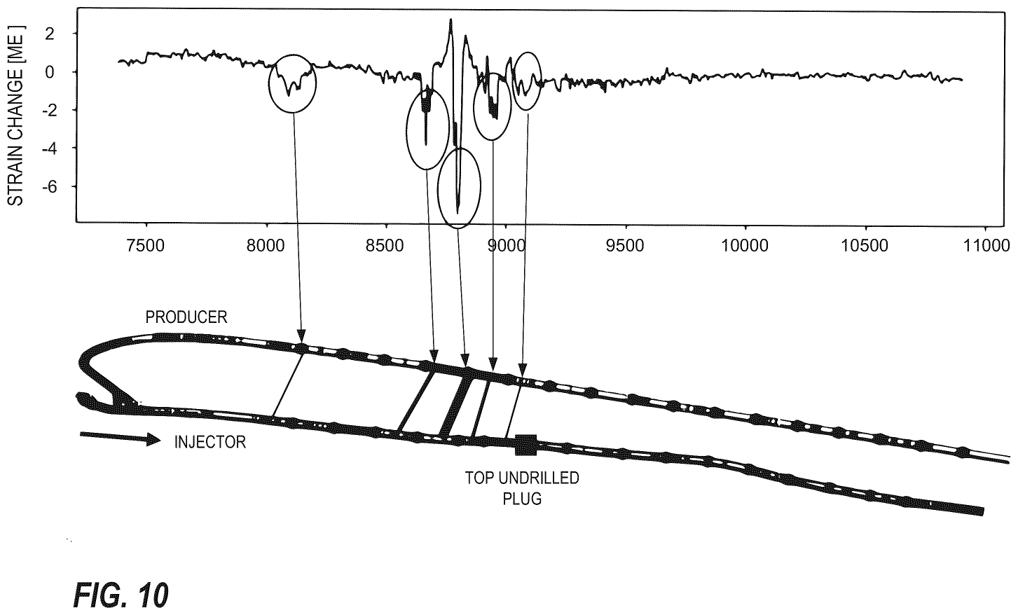

FIG. 10 illustrates strain change recorded in producer after the injection test in the injector with seven heel-most stages open to a reservoir, in accordance with some examples. The wells schematic of the injector and producer wells, with possible flow paths indicated in orange and the top undrilled plug indicated by a square.

FIG. 10 shows commutative strain change in 3.5 hours after the stop of an injection test. After thermal correction, the negative strain change appears in at least five zones along the producer lateral. This negative strain signal corresponds with decreased fracture aperture in the producer well after the end of the injector injection test. The DSS response confirmed the hydraulic communication between the injector and producer doublet before producer stimulation. The possible fracture paths are indicated in orange and match the expected stress field orientation.

Permanent deployment of fiber optic cable in geothermal wells allows for extensive monitoring capabilities during various phases of the well field development. After a well is drilled and instrumented, DTS can be used to monitor warm back to undisturbed temperature conditions to validate temperature model. DTS provides information on temperature distribution inside the well during any in-well operations, such as plug drill out or flow back, which helps to mitigate risks associated with running equipment in a high-temperature well, or producing geothermal fluid. During stimulation, both in-well and cross-well DFOS data help to evaluate the efficiency of the stimulation and characterize the created SRV. This is useful for optimizing completion design to create hydraulic connections and guide well spacing decisions in a multi-well horizontal geothermal system for optimal energy production. When the wells are put into production, DFOS may be used to understand the flow distribution within the injector and producer and run preventive measures to establish a uniform flow path for equal heat exchange within the reservoir. Vertical monitoring well does not directly contribute to energy production but is useful for well field de-risking, temperature profiling, LFDAS, and microseismic monitoring.

Additional requirements may be imposed on the cement quality to mitigate cable erosion, which is challenging due to high in-situ temperatures. The temporarily deployed fiber optic offerings for high-temperature horizontal wells are of interest for various monitoring applications.

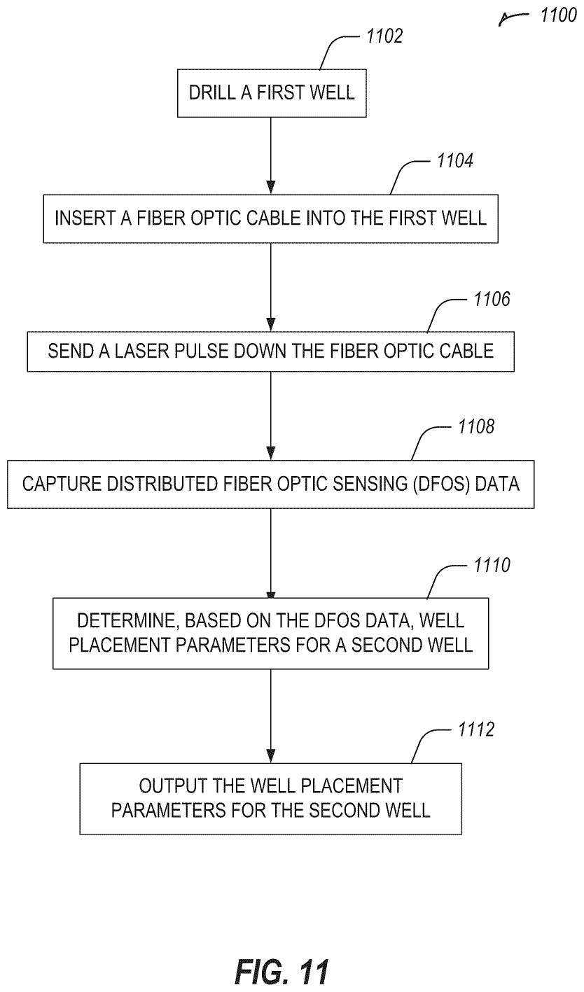

FIG. 11 illustrates a flowchart showing a technique for obtaining information corresponding to a well of a reservoir, in accordance with some examples. The technique 1100 may be implemented using processing circuitry, for example to execute operations 1110, 1112, etc.

The technique 1100 includes an operation 1102 to drill a first well.

The technique 1100 includes an operation 1104 to insert a fiber optic cable into the first well. The fiber optic cable may be permanently cemented behind a casing of the well. In an example, the fiber optic cable is configured to withstand heat of 500 F or more in the first well.

The technique 1100 includes an operation 1106 to send a laser pulse down the fiber optic cable.

The technique 1100 includes an operation 1108 to capture distributed fiber optic sensing (DFOS) data. The DFOS data may include at least one of distributed temperature sensing (DTS) data, distributed acoustic sensing (DAS) data, distributed strain sensing (DSS) data, or the like. The DFOS data may include low-frequency DAS (LF-DAS) data.

The technique 1100 includes an operation 1110 to determine, based on the DFOS data, well placement parameters for a second well. In an example, the first well is an injector well and the second well is a producer well.

The technique 1100 includes an operation 1112 to output the well placement parameters for the second well.

The technique 1100 may include using the DFOS data to confirm a model of the reservoir. The technique 1100 may include determining, using the DFOS data, fracture initiation and flow allocation for the first well, and outputting the fracture initiation and flow allocation for the first well. The technique 1100 may include characterizing, using the DFOS data, plug-and-perf completion design for the first well, and outputting the plug-and-perf completion design for the first well. The technique 1100 may include determining, using the DFOS data, stimulated reservoir volume (SRV) dimensions for the reservoir, and outputting the stimulated reservoir volume (SRV) dimensions for the reservoir.

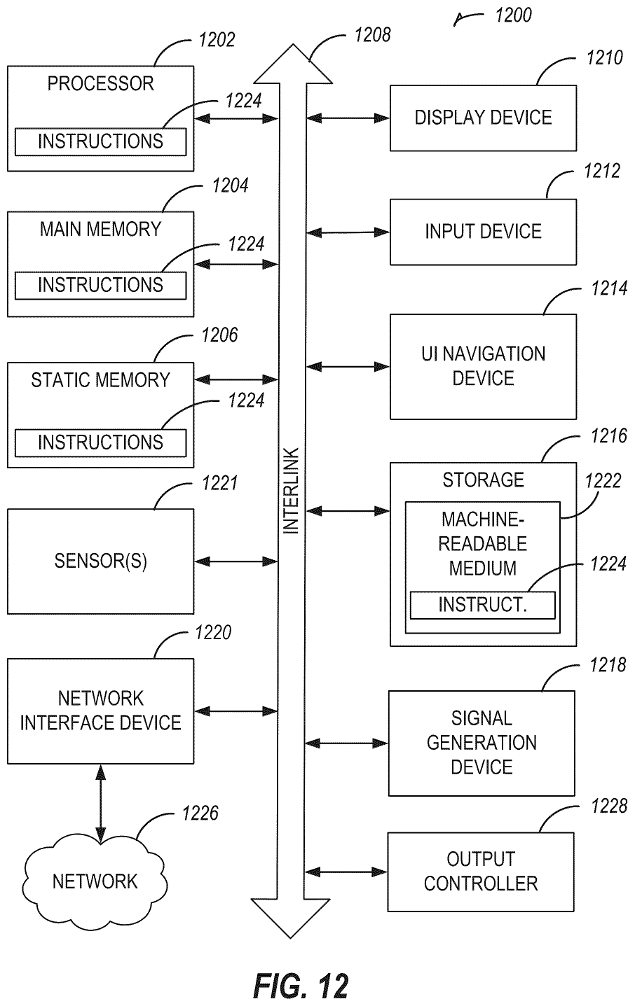

FIG. 12 illustrates generally an example of a block diagram of a machine 1200 upon which any one or more of the techniques (e.g., methodologies) discussed herein may perform in accordance with some examples. In alternative embodiments, the machine 1200 may operate as a standalone device or may be connected (e.g., networked) to other machines. In a networked deployment, the machine 1200 may operate in the capacity of a server machine, a client machine, or both in server-client network environments. In an example, the machine 1200 may act as a peer machine in peer-to-peer (P2P) (or other distributed) network environment. The machine 1200 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 1200 may include a hardware processor 1202 (e.g., a central processing unit (CPU), a graphics processing unit (GPU), a hardware processor core, or any combination thereof), a main memory 1204 and a static memory 1206, some or all of which may communicate with each other via an interlink (e.g., bus) 1208. The machine 1200 may further include a display unit 1210, an alphanumeric input device 1212 (e.g., a keyboard), and a user interface (UI) navigation device 1214 (e.g., a mouse). In an example, the display unit 1210, alphanumeric input device 1212 and UI navigation device 1214 may be a touch screen display. The machine 1200 may additionally include a storage device (e.g., drive unit) 1216, a signal generation device 1218 (e.g., a speaker), a network interface device 1220, and one or more sensors 1221, such as a global positioning system (GPS) sensor, compass, accelerometer, or other sensor. The machine 1200 may include an output controller 1228, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1216 may include a machine readable medium 1222 that is non-transitory on which is stored one or more sets of data structures or instructions 1224 (e.g., software) embodying or utilized by any one or more of the techniques or functions described herein. The instructions 1224 may also reside, completely or at least partially, within the main memory 1204, within static memory 1206, or within the hardware processor 1202 during execution thereof by the machine 1200. In an example, one or any combination of the hardware processor 1202, the main memory 1204, the static memory 1206, or the storage device 1216 may constitute machine readable media.

While the machine readable medium 1222 is illustrated as a single medium, the term “machine readable medium” may include a single medium or multiple media (e.g., a centralized or distributed database, or associated caches and servers) configured to store the one or more instructions 1224.

The term “machine readable medium” may include any medium that is capable of storing, encoding, or carrying instructions for execution by the machine 1200 and that cause the machine 1200 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1224 may further be transmitted or received over a communications network 1226 using a transmission medium via the network interface device 1220 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 1220 may include one or more physical jacks (e.g., Ethernet, coaxial, or phone jacks) or one or more antennas to connect to the communications network 1226. In an example, the network interface device 1220 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1200, and includes digital or analog communications signals or other intangible medium to facilitate communication of such software.

In view of the disclosure above, various examples are set forth below. It should be noted that one or more features of an example, taken in isolation or combination, should be considered within the disclosure of this application.

Example 1 is a method for obtaining information corresponding to a well of a reservoir, the method comprising: drilling a first well; inserting a fiber optic cable into the first well; sending a laser pulse down the fiber optic cable; capturing distributed fiber optic sensing (DFOS) data; determining, based on the DFOS data, well placement parameters for a second well; and outputting the well placement parameters for the second well.

In Example 2, the subject matter of Example 1 comprises, wherein the first well is an injector and the second well is a producer.

In Example 3, the subject matter of Examples 1-2 comprises, wherein the DFOS data comprises at least one of distributed temperature sensing (DTS) data, distributed acoustic sensing (DAS) data, or distributed strain sensing (DSS) data.

In Example 4, the subject matter of Examples 1-3 comprises, wherein the DFOS data comprises low-frequency DAS (LF-DAS) data.

In Example 5, the subject matter of Examples 1-4 comprises, wherein the fiber optic cable is permanently cemented behind a casing of the well.

In Example 6, the subject matter of Examples 1-5 comprises, wherein the fiber optic cable is configured to withstand heat of 500 F in the first well.

In Example 7, the subject matter of Examples 1-6 comprises, using the DFOS data to confirm a model of the reservoir.

In Example 8, the subject matter of Examples 1-7 comprises, determining, using the DFOS data, fracture initiation and flow allocation for the first well, and outputting the fracture initiation and flow allocation for the first well.

In Example 9, the subject matter of Examples 1-8 comprises, characterizing, using the DFOS data, plug-and-perf completion design for the first well, and outputting the plug-and-perf completion design for the first well.

In Example 10, the subject matter of Examples 1-9 comprises, determining, using the DFOS data, stimulated reservoir volume (SRV) dimensions for the reservoir, and outputting the stimulated reservoir volume (SRV) dimensions for the reservoir.

Example 11 is a system for obtaining information corresponding to a well of a reservoir, the system comprising: a first well drilled in the reservoir; a fiber optic cable inserted into the first well; an interrogator unit to send a laser pulse down a fiber optic cable in a second well; a photodetector to capture distributed fiber optic sensing (DFOS) data based on an optical signal reflected from the laser pulse; processing circuitry; and memory, comprising instructions, which when executed by the processing circuitry, cause the processing circuitry to: determine, based on the DFOS data, well placement parameters for a second well; and output the well placement parameters for the second well.

In Example 12, the subject matter of Example 11 comprises, wherein the first well is an injector and the second well is a producer.

In Example 13, the subject matter of Examples 11-12 comprises, wherein the DFOS data comprises at least one of distributed temperature sensing (DTS) data, distributed acoustic sensing (DAS) data, or distributed strain sensing (DSS) data.

In Example 14, the subject matter of Examples 11-13 comprises, wherein the DFOS data comprises low-frequency DAS (LF-DAS) data.

In Example 15, the subject matter of Examples 11-14 comprises, wherein the fiber optic cable is permanently cemented behind a casing of the well.

In Example 16, the subject matter of Examples 11-15 comprises, wherein the fiber optic cable is configured to withstand heat of 500 F in the first well.

In Example 17, the subject matter of Examples 11-16 comprises, using the DFOS data to confirm a model of the reservoir.

In Example 18, the subject matter of Examples 11-17 comprises, determining, using the DFOS data, fracture initiation and flow allocation for the first well, and outputting the fracture initiation and flow allocation for the first well.

In Example 19, the subject matter of Examples 11-18 comprises, characterizing, using the DFOS data, plug-and-perf completion design for the first well, and outputting the plug-and-perf completion design for the first well.

In Example 20, the subject matter of Examples 11-19 comprises, determining, using the DFOS data, stimulated reservoir volume (SRV) dimensions for the reservoir, and outputting the stimulated reservoir volume (SRV) dimensions for the reservoir.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method for obtaining information corresponding to a well of a reservoir, the method comprising:
drilling a first well;
inserting a fiber optic cable into the first well;
sending a laser pulse down the fiber optic cable;
capturing distributed fiber optic sensing (DFOS) data;
determining, based on the DFOS data, well placement parameters for a second well; and
outputting the well placement parameters for the second well.

2. The method of claim 1, wherein the first well is an injector and the second well is a producer.

3. The method of claim 1, wherein the DFOS data comprises at least one of distributed temperature sensing (DTS) data, distributed acoustic sensing (DAS) data, or distributed strain sensing (DSS) data.

4. The method of claim 1, wherein the DFOS data comprises low-frequency DAS (LF-DAS) data.

5. The method of claim 1, wherein the fiber optic cable is permanently cemented behind a casing of the well.

6. The method of claim 1, wherein the fiber optic cable is configured to withstand heat of 500 F in the first well.

7. The method of claim 1, further comprising using the DFOS data to confirm a model of the reservoir.

8. The method of claim 1, further comprising, determining, using the DFOS data, fracture initiation and flow allocation for the first well, and outputting the fracture initiation and flow allocation for the first well.

9. The method of claim 1, further comprising, characterizing, using the DFOS data, plug-and-perf completion design for the first well, and outputting the plug-and-perf completion design for the first well.

10. The method of claim 1, further comprising, determining, using the DFOS data, stimulated reservoir volume (SRV) dimensions for the reservoir, and outputting the stimulated reservoir volume (SRV) dimensions for the reservoir.

11. A system for obtaining information corresponding to a well of a reservoir, the system comprising:
a first well drilled in the reservoir;
a fiber optic cable inserted into the first well;
an interrogator unit to send a laser pulse down a fiber optic cable in a second well;
a photodetector to capture distributed fiber optic sensing (DFOS) data based on an optical signal reflected from the laser pulse;
processing circuitry; and
memory, comprising instructions, which when executed by the processing circuitry, cause the processing circuitry to:
determine, based on the DFOS data, well placement parameters for a second well; and
output the well placement parameters for the second well.

12. The system of claim 11, wherein the first well is an injector and the second well is a producer.

13. The system of claim 11, wherein the DFOS data comprises at least one of distributed temperature sensing (DTS) data, distributed acoustic sensing (DAS) data, or distributed strain sensing (DSS) data.

14. The system of claim 11, wherein the DFOS data comprises low-frequency DAS (LF-DAS) data.

15. The system of claim 11, wherein the fiber optic cable is permanently cemented behind a casing of the well.

16. The system of claim 11, wherein the fiber optic cable is configured to withstand heat of 500 F in the first well.

17. The system of claim 11, further comprising using the DFOS data to confirm a model of the reservoir.

18. The system of claim 11, further comprising, determining, using the DFOS data, fracture initiation and flow allocation for the first well, and outputting the fracture initiation and flow allocation for the first well.

19. The system of claim 11, further comprising, characterizing, using the DFOS data, plug-and-perf completion design for the first well, and outputting the plug-and-perf completion design for the first well.

20. The system of claim 11, further comprising, determining, using the DFOS data, stimulated reservoir volume (SRV) dimensions for the reservoir, and outputting the stimulated reservoir volume (SRV) dimensions for the reservoir.
